(19) United States
(12) Patent Application Publication
(10) Pub. No.: US 2015/0310414 A1
(43) Pub. Date: Oct. 29, 2015

(54) INFORMATION PROCESSING DEVICE AND METHOD OF CHANGING A TRANSACTION STATEMENT

(71) Applicant: NEC Corporation, Tokyo (JP)

(72) Inventors: Tadashi ITANI, Tokyo (JP); Rumi IKEZAWA, Tokyo (JP)

(21) Appl. No.: 14/418,639

(22) PCT Filed: Apr. 12, 2013
(86) PCT No.: PCT/JP2013/061023

§ 371 Date: Jan. 30, 2015

(30) Foreign Application Priority Data
Aug. 3, 2012 (JP) 2012-173409

(51) Int. Cl. G06Q 20/20

(52) U.S. Cl. CPC G06Q 20/208

(57) ABSTRACT

An information processing device includes: a registration processing unit that, in response to a request for registration of a product as an item to be checked out, acquires a product code that enables identification of the product, and transaction information, each of which concerns the product serving as a target of request, and sequentially stores, in a transaction-information storage unit, the product code and the transaction information, which are acquired on a request basis, as one transaction statement record in the requested order; a display processing unit that causes a display unit to display a registration screen that presents plural items of data corresponding to plural transaction statement records stored in the transaction-information storage unit; an acquiring unit that acquires a product code and request change information corresponding to data designated on the registration screen; and a change processing unit that applies a predetermined record process using the request change information to plural transaction statement records stored in the transaction-information storage unit and each containing the product code acquired by the acquiring unit.

### TECHNICAL FIELD

The present invention relates to a point of sale (POS) terminal and a POS system.

### BACKGROUND ART

A register operator sequentially registers products that a purchaser brings, as items to be checked out at a cash register in a store, and performs settlement processing after all the products are registered as items to be checked out. At the time of the registration operations, corrections are sometimes necessary for contents that have already been registered as items to be checked out due to error in input of the number of purchased items, selling price, or discounted price, or request for cancellation made by a purchaser, or other reasons.

Patent Document 1 described below proposes a method of easily editing the quantity, the selling price, and discount in data concerning sold products for which registration has been fixed. The method proposed in the Patent Document 1 described below includes: displaying a registration screen including a statement area showing a list of products of which sales data is stored; setting a product designated and inputted from this statement area, as an editing target; reading the sales data on this product serving as the editing target; displaying an editing screen for the read sales data; receiving the editing of this sales data; and updating this sales data with data that has been edited.

### RELATED DOCUMENT

### Patent Document

Patent Document 1: Japanese Patent Application Laid-open No. 2011-22919

### SUMMARY OF THE INVENTION

### Problem to be Solved by the Invention

There are at least two forms of transaction statements generated in response to registration of products as items to be checked out. The first form is a form in which the same products are brought together as much as possible regardless of the sequence of registration during registration operations, thereby generating one transaction statement. With this form, for example, in the case where a register operator performs registration operation (scanning operation) for three tomatoes on a one-by-one basis, one transaction statement indicating three tomatoes is generated. The second form is a form in which a transaction statement is generated for registration of each product as an item to be checked out so that each transaction statement corresponds to each registration operation. With this form, in the case of the example described above, three transaction statements each indicating one tomato are generated.

Here, the transaction statement is generated in order to identify a settlement target, and serves as source data of information which is stored in journal data after the settlement is completed and is outputted on a receipt.

Patent Document 1 described above, however, does not take the transaction statement in the second form into consideration. Thus, in the case where the proposed method as described above is applied to a POS system in which the transaction statement in the second form is generated, correction operation needs to be made separately for each of the transaction statements in order to change transaction information on a certain product, which leads to a deterioration in work efficiency.

The present invention has been made in view of the circumstances described above, and provides a technique that enables a register operator to efficiently correct plural transaction statements concerning the same product.

### Means for Solving the Problem

Each aspect of the present invention employs the following configurations to solve the problem described above.

An information processing device according to the first aspect includes: a registration processing unit that, in response to a request for registration of a product as an item to be checked out, acquires a product code that enables identification of the product, and transaction information, each of which concerns the product serving as a target of request, and sequentially stores, in a transaction-information storage unit, the product code and the transaction information, which are acquired on a request basis, as one transaction statement record in the requested order; a display processing unit that causes a display unit to display a registration screen that presents plural items of data corresponding to plural transaction statement records stored in the transaction-information storage unit; an information acquiring unit that acquires a product code and request change information corresponding to data designated through user operation performed on the registration screen; a change processing unit that applies a predetermined record process using the request change information to plural transaction statement records stored in the transaction-information storage unit and each containing the product code acquired by the information acquiring unit.

A method of changing a transaction statement according to the second aspect is performed by an information processing device, and includes: in response to a request for registration of a product as an item to be checked out, acquiring a product code that enables identification of the product, and transaction information, each of which concerns the product serving as a target of request; sequentially storing, in a transaction-information storage unit, the product code and the transaction information, which are acquired on a request basis, as one transaction statement record in the requested order; causing a display unit to display a registration screen that presents plural items of data corresponding to plural transaction statement records stored in the transaction-information storage unit; acquiring a product code and request change information corresponding to data designated through user operation performed on the registration screen; and applying a predetermined record process using the request change information to plural transaction statement records stored in the transaction-information storage unit and each containing the product code corresponding to the data designated through the user operation.

It should be noted that other aspects of the present invention may include a program that causes the information processing device to realize the configuration of the first aspect described above, or may include a computer-readable storage medium that records such a program. This storage medium includes a non-transitory tangible medium.

### Effect of the Invention

According to each of the aspects described above, it is possible to enable a register operator to efficiently correct plural transaction statements concerning the same product.

### BRIEF DESCRIPTION OF THE DRAWINGS

The above-described object, other objects, features and advantages will be made further clear by the preferred exemplary embodiments described below and the following drawings attached thereto.

FIG. 1 is a diagram illustrating an example of a configuration of an appearance of a POS register device according to a first exemplary embodiment.

FIG. 2 is a diagram schematically illustrating an example of a hardware configuration of the POS register device according to the first exemplary embodiment.

FIG. 3 is a diagram schematically illustrating an example of a process configuration of part of the POS register device according to the first exemplary embodiment.

FIG. 4 is a diagram illustrating an example of information stored in a transaction-information storage unit.

FIG. 5 is a diagram illustrating an example of a registration screen.

FIG. 6 is a diagram illustrating an example of a designation changing screen in a selection statement mode.

FIG. 7 is a diagram illustrating an example of a designation changing screen in an all item mode.

FIG. 8 is a flowchart showing an example of operations performed by the POS register device according to the first exemplary embodiment.

FIG. 9 is a diagram illustrating an example of change for a normal product.

FIG. 10 is a diagram illustrating an example of change for a limited sales product.

FIG. 11 is a diagram schematically illustrating an example of a configuration of a POS system according to a modification example.

### DESCRIPTION OF EMBODIMENTS

Hereinbelow, exemplary embodiments according to the present invention will be described. Note that each exemplary embodiment described below is merely an example, and the present invention is not limited to configurations of each of the exemplary embodiments described below.

### First Exemplary Embodiment

### Device Configuration

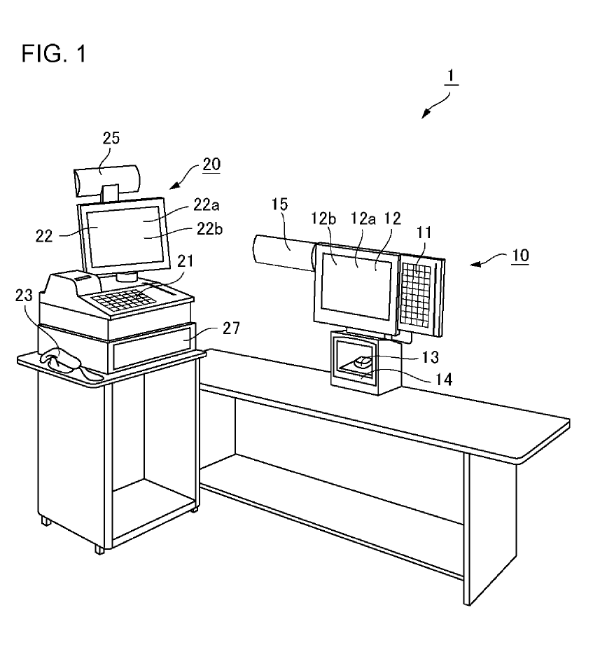

FIG. 1 is a diagram illustrating an example of a configuration of an appearance of a POS register device according to a first exemplary embodiment. As illustrated in FIG. 1, the POS register device 1 according to the first exemplary embodiment includes a checker device 10 and a cashier device 20. The POS register device 1, the checker device 10, and the cashier device 20 are also referred to as POS terminals.

The checker device 10 registers a product as an item to be checked out, and transmits information on the product to be checked out, to the cashier device 20. The checker device 10 includes, for example, a keyboard 11, a touch screen unit 12, a scanning device 13, and a display 15 for purchaser. The display 15 for purchaser displays, for example, selling price information on the product registered as an item to be checked out.

The touch screen unit 12 includes, for example, a display unit 12a, a touch screen 12b that receives user operations, and a controlling unit. The touch screen unit 12 causes the display unit 12a to display a screen corresponding to drawing data received, and obtains input from a user (a member of staff such as a register operator) by sensing touch to the touch screen 12b from the outside. The touch screen unit 12 transmits the input information acquired. The display unit 12a displays, for example, a sales registration screen indicating a list of products registered as items to be checked out.

The scanning device 13 detects a product identification label attached on a package of a product held toward a scanning window 14, and further, captures a product image showing the appearance of this product. More specifically, the scanning device 13 causes light from the product through the scanning window 14 to be focused, as an optical image, onto image sensors such as charge coupled devices (CCD), and acquires image data on this product on the basis of electrical signals corresponding to this image. The scanning device 13 may detect the product identification label from the product image captured by the image sensor. In this case, the scanning device 13 has a function of automatically adjusting a focal length, an angle of view or the like at the time of capturing the product image as well as at the time of capturing an image of the product identification label. Furthermore, the scanning device 13 may further include a laser scanner, and detect the product identification label using this laser scanner.

Here, the product identification label represents a code symbol in which a product code, which is formed by a character, number, sign, or the like and from which each product can be identified, is encoded, and is realized, for example, in a form of a one-dimensional bar code, a two-dimensional bar code, and so on. This exemplary embodiment does not limit the way in which the product identification label is realized, provided that the product code can be extracted from the product identification label. The scanning device 13 extracts the product code by decoding the detected product identification label.

Furthermore, the product code is identification data set in advance to identify each product, and formed, for example, by characters, numbers, and symbols. For the product code, a Price Look Up (PLU) code, a Non-PLU code, and the like are used, for example. Furthermore, for the product code read on the product identification label, a Japan Article Number (JAN) code is used, for example.

As described above, the checker device 10 identifies the product on the basis of, for example, the product code extracted from the product identification label using the scanning device 13, a product code acquired by operation of the checkout screen, or a product code directly inputted through, for example, the keyboard 11, and registers this product as the item to be checked out.

The cashier device 20 performs settlement processing for the product to be checked out. Basically, the checker device 10 registers an item to be checked out as described above. However, the cashier device 20 itself may additionally register the item to be checked out. In such a case, the cashier device 20 identifies the product on the basis of the product code acquired, for example, from the product identification label using a handheld scanner 23, or a product code (or segment code) directly inputted through, for example, a keyboard 21, and additionally registers this product as the item to be checked out.

The cashier device 20 includes, for example, the keyboard 21, a touch screen unit 22, the handheld scanner 23, a display 25 for purchaser, and a cash drawer 27. The cash drawer 27 stores paper money, coins, cash voucher or other form of money used in settlement of products. In this exemplary embodiment, an example is given in which the cash drawer 27 has an automated change machine.

The touch screen unit 22 has a configuration similar to that of the touch screen unit 12 described above, and the touch screen unit 22 includes, for example, a display unit 22a, and a touch screen 22b. The display unit 22a displays, for example, a sales registration screen and a payment screen. The display 25 for purchaser displays, for example, the total purchase price, and the amount of change.

The handheld scanner 23 reads the product identification label attached on a package of the product as is the case with the scanning device 13 described above, and furthermore, captures a product image showing the appearance of the product. It is only necessary that the handheld scanner 23 has a configuration similar to that of the scanning device 13 described above, and hence, explanation thereof will not be repeated.

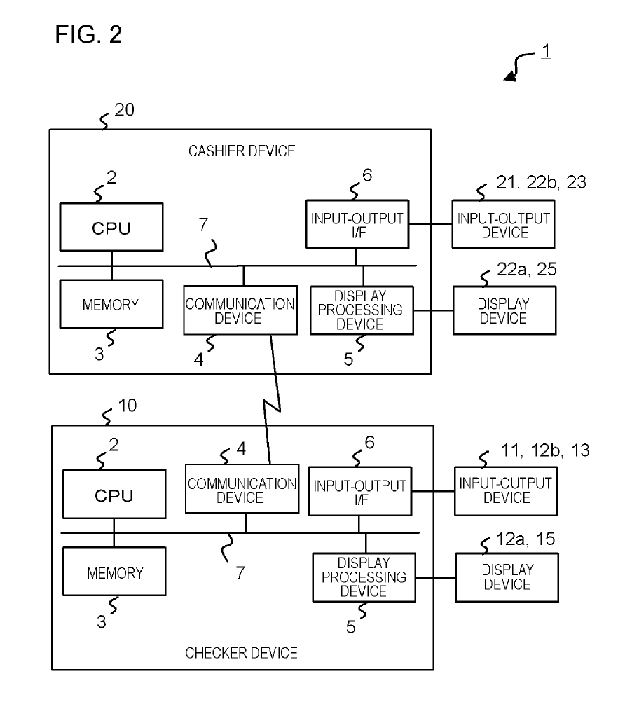

FIG. 2 is a diagram schematically illustrating an example of a hardware configuration of the POS register device 1 according to the first exemplary embodiment. As illustrated in FIG. 2, the checker device 10 includes, for example, a central processing unit (CPU) 2, a memory 3, a communication device 4, a display processing device 5, and an input-output interface (I/F) 6. These units are connected, for example, to a bus 7. The memory 3 includes, for example, a random access memory (RAM), a read only memory (ROM), a hard disk, and a portable storage medium. The communication device 4 communicates with other devices (for example, the cashier device 20) in a wired or wireless manner.

The display processing device 5 is connected to a display device, and transmits, to the display device, a screen-displaying signal for displaying a given screen in accordance with a process performed by the CPU 2. The checker device 10 includes the display 15 for purchaser and the display unit 12a of the touch screen unit 12, each of which serves as the display device.

The input-output I/F 6 is connected to an input-output device. The input-output I/F 6 outputs, for example, voice to an output device in accordance with a process performed by the CPU 2, and receives an input signal from an input device. The checker device 10 includes the keyboard 11, the touch screen 12b of the touch screen unit 12, and the scanning device 13, each of which serves as the input-output device.

The cashier device 20 includes, for example, a CPU 2, a memory 3, a communication device 4, a display processing device 5, and an input-output I/F 6 as is the case with the checker device 10. The cashier device 20 includes the display 25 for purchaser and the display unit 22a of the touch screen unit 22, each of which serves as the display device. The cashier device 20 includes the keyboard 21, the touch screen 22b of the touch screen unit 22, and the handheld scanner 23, each of which serves as the input-output device.

It should be noted that this exemplary embodiment does not limit the hardware configurations of the checker device 10 and the cashier device 20 as described above. For example, the keyboards 11 and 21 may be replaced with software keyboards. Furthermore, the displays 15 and 25 for purchaser may be integrated as one unit, or may be realized as displays that display contents equivalent to those displayed on the display unit 12a of the touch screen unit 12 and the display unit 22a of the touch screen unit 22.

### [Process Configuration]

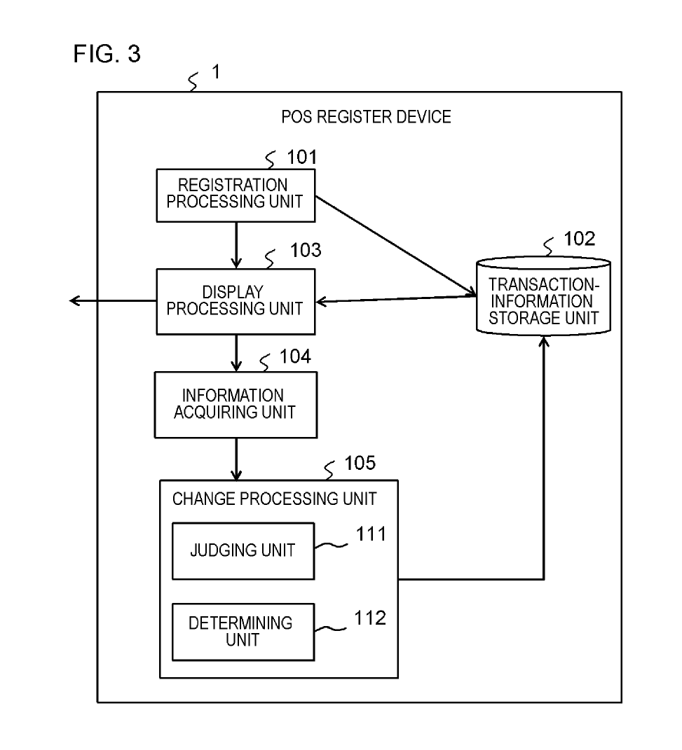

FIG. 3 is a diagram schematically illustrating an example of a process configuration of part of the POS register device 1 according to the first exemplary embodiment. The POS register device 1 includes, for example, a registration processing unit 101, a transaction-information storage unit 102, a display processing unit 103, an information acquiring unit 104, and a change processing unit 105. Each of these processing modules is realized, for example, with the CPU 2 running a program stored in the memory 3. Furthermore, this program may be installed, for example, from a portable storage medium such as a compact disc (CD) and a memory card or other devices, and may be stored in the memory 3.

Although FIG. 3 illustrates only the process configuration related to registration of products as items to be checked out, the POS register device 1 has a large number of processing modules other than those illustrated in the drawing. Furthermore, these processing modules are realized in each of the checker device 10 and the cashier device 20 although the checker device 10 and the cashier device 20 are not illustrated in a separated manner in FIG. 3. However, it may be possible to employ a configuration in which the transaction-information storage unit 102 is realized only in the cashier device 20, and is accessed by the checker device 10 and the cashier device 20 through a communication processing unit (not illustrated).

In response to a request for registration of a product as an item to be checked out, the registration processing unit 101 acquires a product code that enables identification of this product and transaction information, each of which concerns the product for which the request is made, and sequentially stores the product code and the transaction information, which are acquired on a request basis, as one transaction statement record in the requested order in the transaction-information storage unit 102. Here, registration of a product as an item to be checked out corresponds to a process in which this registration processing unit 101 stores a transaction statement record in the transaction-information storage unit 102. As described above, the transaction statement record treated in this exemplary embodiment corresponds to the second form described above. Note that, for example, in the case where no product code is attached to a product to be checked out, another code such as a segment code may be used instead of the product code.

The product code, the transaction information, and the request for registration are acquired from other processing modules (not illustrated). The transaction information includes, for example, selling price information, discount information, special sales information, and the quantity sold. The special sales information is information that enables determination as to whether a product is a limited sales product to which a limited sales price is applied, and is realized, for example, as a flag data. Hereinafter, limited sales products to which a limited sales price is applied are also referred to as limited-sale-price applied products, and a portion of the limited sales products of which quantity falls beyond the quantity limit and to which the limited sales price is not applied is also referred to as limited-sale-price unapplied products.

The other processing modules described above acquire the product code and the quantity sold concerning the product to be checked out, for example, through operation performed on the checkout screen through the touch screen unit 12 or 22, or scanning operation performed to the product identification label attached to the product using the scanning device 13 or the handheld scanner 23. The other processing modules described above extract product information concerning a product associated with this product code from a product information table (not illustrated), and send this product information, the quantity sold, and the request for registration of the product as the item to be checked out, to the registration processing unit 101. With these operations, the quantity sold and information contained in the product information are stored in the transaction-information storage unit 102 as the transaction statement record.

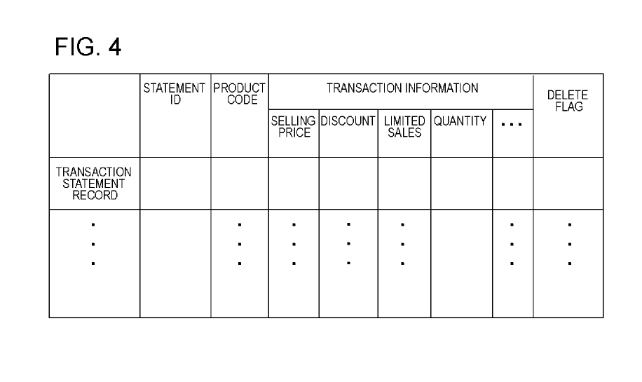

FIG. 4 is a diagram illustrating an example of information stored in the transaction-information storage unit 102. As illustrated in the example in FIG. 4, the transaction-information storage unit 102 stores a transaction statement record corresponding to each request for registration in the order of request for registration. Each transaction statement record contains, for example, a statement ID that enables identification of the record, a product code and transaction information, each of which concerns each product, and a delete flag. In FIG. 4, the special sales information described above is denoted as a “limited sales.” Here, the delete flag indicates whether the transaction statement record is in the deleted state. The default value of the delete flag indicates that the transaction statement record is not in the deleted state.

The display processing unit 103 causes the display unit 12a or 22a to display a registration screen which presents plural items of data corresponding to respective transaction statement records stored in the transaction-information storage unit 102. More specifically, the display processing unit 103 generates drawing data on a registration screen, which contains, for example, transaction information in each transaction statement record stored in the transaction-information storage unit 102 and a product name corresponding to a product code concerning the transaction statement record, and transmits the generated drawing data to the display processing device 5. As a result, with control performed by the display processing device 5, this registration screen is displayed on the display unit 12a or 22a. Note that the product name is acquired, for example, from a product information table (not illustrated) on the basis of the product code.

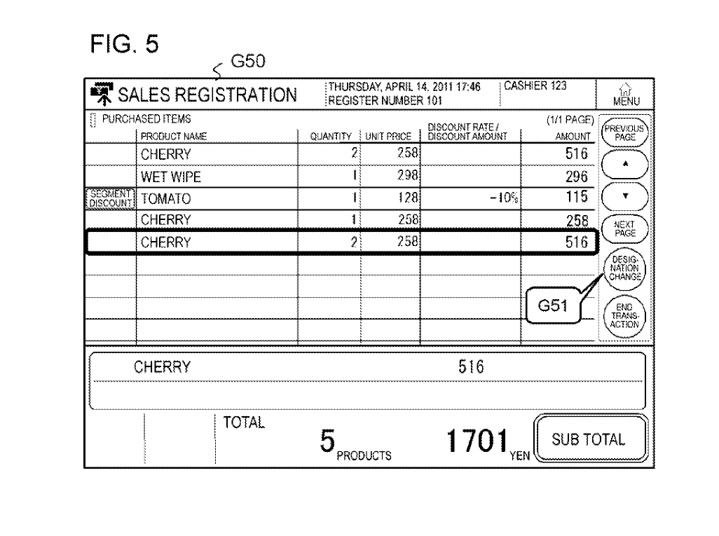

FIG. 5 is a diagram illustrating an example of a registration screen. In the example illustrated in FIG. 5, a registration screen G50 displays product names and transaction information (quantity, unit price information, discount information, the total purchase price) so as to correspond to respective transaction statement records. In the example illustrated in FIG. 5, data in each line of the list displayed corresponds to each transaction statement record, and data in the final line is selected. The display processing unit 103 updates the registration screen G50 every time a product is registered as an item to be checked out, in other words, every time a transaction statement record is stored in the transaction-information storage unit 102. With this operation, a product registered as an item to be checked out is additionally displayed on the registration screen G50 one after another.

The display processing unit 103 presents, on the registration screen, data corresponding to a transaction statement record having a delete flag indicating the deleted state in a form showing the deleted state. For example, in the example illustrated in FIG. 5, the display processing unit 103 draws a strike-through line through a line (data) corresponding to the transaction statement record indicating the deleted state.

Furthermore, upon detecting that a designation changing button G51 is pressed on the registration screen G50 through the touch screen 12b or 22b, the display processing unit 103 causes the display unit 12a or 22a to display a designation changing screen for changing a transaction statement record corresponding to the line (data) selected on the registration screen G50.

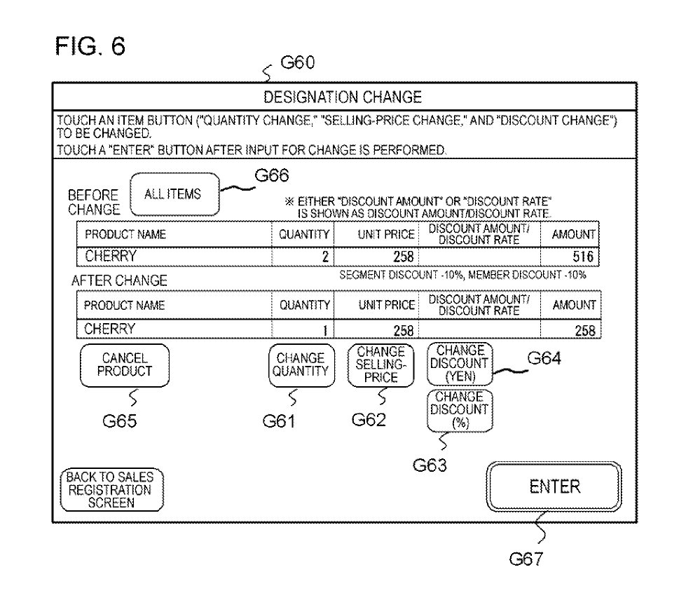

FIG. 6 is a diagram illustrating an example of the designation changing screen in a selection statement mode. The selection statement mode represents an operational mode in which transaction information in one transaction statement record corresponding to the line (data) selected on the registration screen G50 can be changed, and this one transaction statement record can be deleted. A designation changing screen G60 illustrated in FIG. 6 contains data (upper portion) corresponding to the transaction statement record before change is made, and data (lower portion) corresponding to the canceled statement record after change has been made. In the example illustrated in FIG. 6, data (product name: cherry, quantity: two, unit price: 258 yen, total amount: 516 yen) selected on the registration screen G50 in FIG. 5 are displayed as the data before change is made.

Furthermore, the designation changing screen G60 contains a quantity changing button G61, a selling-price changing button G62, a discount changing button G64, a discount-percentage changing button G63, and a product canceling button G65. A user operates these buttons on the designation changing screen G60, whereby transaction information after change has been made is set on the designation changing screen G60. More specifically, in response to operation performed to the quantity changing button G61, the quantity sold that has been changed is set. In response to operation performed to the selling-price changing button G62, unit price information that has been changed is set. In response to operation performed to the discount changing button G64 and the discount-percentage changing button G63, discount information that has been changes is set. With operation performed to the product canceling button G65, it is set that transaction information should be deleted.

Upon detecting user operation performed to an enter button G67 on the designation changing screen G60, the display processing unit 103 acquires the set transaction information after change has been made, as request change information, and transmits, to the information acquiring unit 104, this request change information together with a statement ID of the transaction statement record corresponding to the line (data) selected on the registration screen G50, and mode information indicating a selection statement mode. The request change information contains data after change has been made, in association with each transaction information type. For example, in the case where the quantity is changed from “2” to “1” as in the example in FIG. 6, data indicating the transaction information type “quantity” and data “1” after change has been made are set in the request change information.

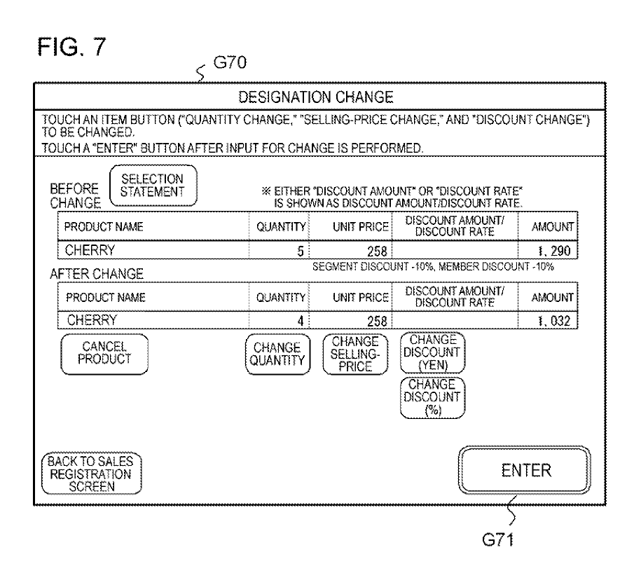

FIG. 7 is a diagram illustrating an example of a designation changing screen in an all item mode. Upon detecting that user operation of pressing an all-item button G66 on the designation changing screen G60 in a state where the designation changing screen G60 in the selection statement mode is being displayed, the display processing unit 103 displays a designation changing screen G70 in the all item mode as illustrated in FIG. 7. The transaction statement record to be changed or deleted in the all item mode is different from that in the selection statement mode. More specifically, the selection statement mode targets the transaction information in one canceled statement record, whereas the all item mode targets cancel information in plural canceled statement records each containing a product corresponding to a line (data) selected on the registration screen G50. Thus, on the designation changing screen G70 illustrated in FIG. 7, plural transaction statement records each containing a product corresponding to a line (data) selected on the registration screen G50 are integrally displayed in the upper portion of the designation changing screen G70 as data before change is made.

On the designation changing screen G70, a user operates each button similar to that on the designation changing screen G60 described above, whereby transaction information after change has been made is set on the designation changing screen G70. Upon detecting user operation performed to an enter button G71 on the designation changing screen G70 in the all item mode, the display processing unit 103 acquires the set transaction information after change has been made, as request change information, and transmits, to the information acquiring unit 104, this request change information together with the statement ID of the transaction statement record corresponding to a line (data) selected on the registration screen G50 as well as mode information indicating the all item mode. The request change information contains data after change has been made in connection with each transaction information type. In the case where the quantity is changed from “5” into “4” as illustrated in the example in FIG. 7, “quantity,” which is data indicated as the transaction information type, and “4,” which is data after change has been made, are set in the request change information, for example.

The information acquiring unit 104 acquires, from the display processing unit 103, the mode information, the statement ID corresponding to the data designated through the user operation performed on the registration screen, and the request change information. If the mode information indicates the all item mode, the information acquiring unit 104 extracts a product code in the transaction statement record identified on the basis of the acquired statement ID from the transaction-information storage unit 102.

If the mode information acquired by the information acquiring unit 104 indicates the all item mode, the change processing unit 105 applies, on the basis of the product code and the request change information acquired by the information acquiring unit 104, a predetermined record process using this request change information to plural transaction statement records stored in the transaction-information storage unit 102 and each containing this product code. On the other hand, if the mode information acquired by the information acquiring unit 104 indicates the statement selection mode, the change processing unit 105 applies, on the basis of the statement ID and the request change information acquired by the information acquiring unit 104, a predetermined record process using this request change information to one transaction statement record stored in the transaction-information storage unit 102 and identified on the basis of this statement ID.

Below, descriptions will be made in detail of the predetermined record process performed by the change processing unit 105 in the case where the mode information indicates the all item mode.

More specifically, as for the predetermined record process, the change processing unit 105 sets the delete flag of each of the plural transaction statement records each containing the product code acquired by the information acquiring unit 104, to be in the deleted state, and at the same time, adds one new transaction statement record having the request change information reflected therein, to the transaction-information storage unit 102. The new transaction statement record having the request change information reflected therein corresponds to data after change has been made (cherry, the quantity: four, and the unit price: 258 yen) in the case of the example illustrated in FIG. 7. Thus, in this case, if there are plural transaction statement records each associated with the same product, the original plural transaction statement records are made to be in the deleted state according to the delete flag, and one transaction statement record containing the transaction information changed in association with this product is added.

The change processing unit 105 may restrict the transaction statement record to which the predetermined record process is applied, on the basis of discount information in a statement transaction record identified with the statement ID acquired by the information acquiring unit 104. Even if it is the same product, the discount amount (discount rate) applied differs between closeout items and other items, and hence, it is not possible to integrate the closeout items and the other items as one product. Thus, for example, in the case where discount information, contained in a transaction statement record stored in the transaction-information storage unit 102 and identified on the basis of the statement ID acquired by the information acquiring unit 104, indicates that discount is not applied, the change processing unit 105 excludes any transaction statement record having discount information indicating that discount is applied, of all transaction statement records stored in the transaction-information storage unit 102 and each containing the product code acquired by the information acquiring unit 104, from targets of application of the predetermined record process described above. On the other hand, in the case where this discount information indicates that discount is applied, the change processing unit 105 excludes any transaction statement record having the discount information indicating that discount is not applied, of all transaction statement records stored in the transaction-information storage unit 102 and containing the product code acquired by the information acquiring unit 104, from targets of application of the predetermined record process described above.

Furthermore, the change processing unit 105 may judge whether the request change information acquired by the information acquiring unit 104 is appropriate or not. For example, in the case of a limited sales product for which discount is applied to only the limited quantity of the products sold, there may be a case where the same transaction information cannot be applied uniformly. In the case where the limited sales products of which quantity exceeds the quantity limit have been registered as an item to be checked out, a record in which discount is applied and a record in which discount is not applied exist in a mixed manner in transaction statement records concerning the same product (limited sales product).

In order to deal with such a case, the change processing unit 105 includes a judging unit 111 and a determining unit 112. Note that, in FIG. 3, for the purpose of explanation, the judging unit 111 and the determining unit 112 are illustrated in a manner such that they are contained in the change processing unit 105. However, the configuration thereof is not limited to the configuration as described above.

The judging unit 111 judges whether the product code acquired by the information acquiring unit 104 corresponds to the limited sales product. More specifically, this judgment is made by judging whether there is any transaction information containing special sales information indicating the limited-sale-price applied product or not in transaction information in plural transaction statement records each containing the product code acquired by the information acquiring unit 104.

Furthermore, if the judging unit 111 judges that the product code corresponds to the limited sales product, and the mode information acquired by the information acquiring unit 104 indicates the all item mode, the judging unit 111 judges whether the quantity sold after change has been made, indicated by the request change information acquired by the information acquiring unit 104, exceeds the quantity limit for the limited sales product. On the other hand, if the judging unit 111 judges that the product code corresponds to the limited sales product, and the mode information acquired by the information acquiring unit 104 indicates the selection statement mode, the judging unit 111 further judges whether the product code of the transaction statement record identified on the basis of the statement ID acquired by the information acquiring unit 104 corresponds to the limited-sale-price applied product. If the judging unit 111 judges that the transaction statement record indicates that the product is the limited-sale-price applied product, the judging unit 111 further judges whether the total quantity sold of the limited sales product stored in the transaction-information storage unit 102 exceeds the quantity limit by assuming that the quantity sold after change has been made, indicated by the request change information acquired by the information acquiring unit 104, is applied to the limited sales product.

Here, the quantity limit for the limited sales product may be acquired on the basis of the special sales information contained in transaction information in the transaction statement record, or may be acquired from a discount information table (not illustrated) or product information table (not illustrated) on the basis of the product code. If the judging unit 111 judges that the product code corresponds to the limited sales product, the judging unit 111 may further judge whether the request change information acquired by the information acquiring unit 104 indicates a change in the discount information.

The determining unit 112 determines whether to cause the change processing unit 105 to perform the predetermined record process on the basis of results of judgment made by the judging unit 111. More specifically, if it is judged that: the mode information indicates the all item mode; the product code acquired by the information acquiring unit 104 corresponds to the limited sales product; and the quantity sold after change has been made, indicated by the request change information acquired by the information acquiring unit 104, exceeds the quantity limit for the limited sales product, the determining unit 112 does not cause the change processing unit 105 to perform the predetermined record process. This is because, in connection with the limited sales product, a transaction statement record indicating that discount is applied and a transaction statement record indicating that discount is not applied necessarily coexist in a mixed manner, and these cannot be integrated into one transaction statement record. In addition, if the mode information indicates the selection statement mode; the statement ID acquired by the information acquiring unit 104 indicates the transaction statement record of the limited-sale-price applied product; and the total quantity sold of the limited sales products, obtained by applying the request change information acquired by the information acquiring unit 104 to the limited sales product, exceeds the quantity limit, the determining unit 112 does not causes the change processing unit 105 to perform the predetermined record process. This is because, in this case, the limited sales price is applied to a surplus quantity of the limited sales products that exceeds the quantity limit. In such a case, the determining unit 112 may instructs the display processing unit 103 to display an alarm indicating that the change set on the designation changing screen G70 in the all item mode is inappropriate.

On the other hand, if it is judged that the product code acquired by the information acquiring unit 104 does not correspond to the limited sales product, or if it is judged that: the mode information indicates the all item mode; the product code corresponds to the limited sales product; and the quantity sold after change has been made, indicated by the request change information, is less than or equal to the quantity limit for the limited sales product, the determining unit 112 causes the change processing unit 105 to perform the predetermined record process described above. In addition, if the mode information indicates the selection statement mode, and the statement ID corresponds to the transaction statement record of the limited sales product to which the limited sales price is not applied, or if the mode information indicates the selection statement mode, the statement ID corresponds to the transaction statement record of the limited-sale-price applied product, and the total quantity sold does not exceed the quantity limit, the determining unit 112 causes the change processing unit 105 to perform the predetermined record process.

Furthermore, if it is judged that the product code corresponds to the limited sales product, and the request change information indicates a change in the discount information, the determining unit 112 may instruct the display processing unit 103 to display an alarm indicating that the discount information on the limited sales product cannot be changed.

### [Example of Operation]

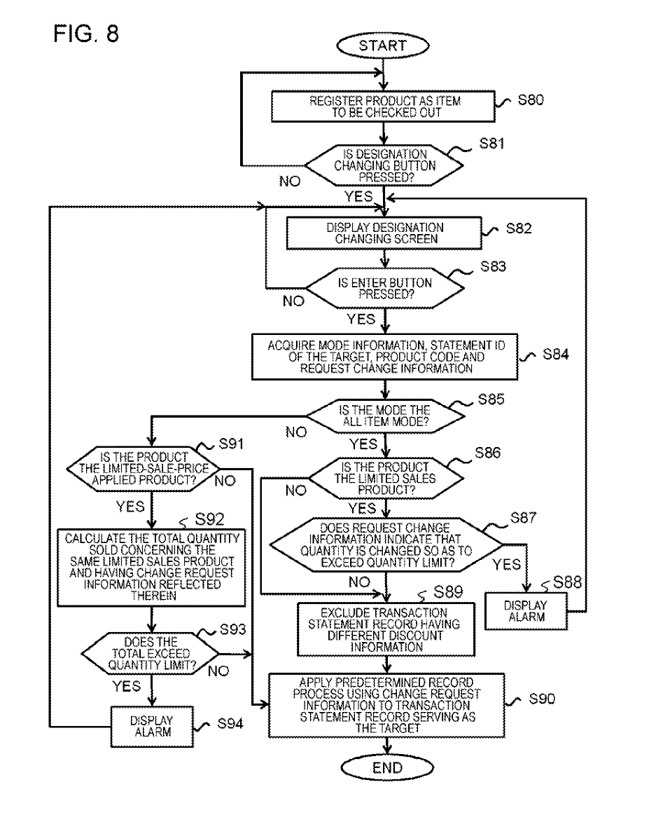

Below, a method of changing a transaction statement according to the first exemplary embodiment will be described with reference to FIG. 8. FIG. 8 is a flowchart showing an example of operations performed by the POS register device 1 according to the first exemplary embodiment. Each step shown in FIG. 8 is performed by either the checker device 10 or the cashier device 20.

The POS register device 1 sequentially registers products as items to be checked out (S80). More specifically, in response to a request for registration of products as items to be checked out, the POS register device 1 acquires a product code that enables identification of this product and transaction information, each of which concerns the product serving as a request target, and sequentially stores the product code and the transaction information, which are acquired on a request basis, as one transaction statement record in the requested order in the transaction-information storage unit 102. At this time, the POS register device 1 displays the registration screen G50 as illustrated in FIG. 5 on the display unit 12a or 22a. Furthermore, every time the transaction statement record is stored, the POS register device 1 adds data corresponding to the stored transaction statement record to the registration screen G50.

Upon detecting that the designation changing button G51 on the registration screen G50 is pressed through user operation (S81), the POS register device 1 displays, on the display unit 12a or 22a, the designation changing screen G60 as illustrated in FIG. 6 that allows changing the transaction statement record corresponding to a line (data) selected on the registration screen G50 (S82). As illustrated in FIG. 6 and FIG. 7, the all item mode and the selection statement mode can be switched on the designation changing screen through the all-item button G66 and a selection statement button. Furthermore, the transaction information after change has been made is set on the designation changing screen G60 or G70 through user operation using the touch screen 12b or 22b, or the keyboard 11 or 21.

Upon detecting that the enter button G67 on the designation changing screen G60 or the enter button G71 on the designation changing screen G70 is pressed through user operation (S83), the POS register device 1 acquires the mode information, the statement ID of the transaction statement record corresponding to data selected on the registration screen G50, the product code, and the request change information (S84). The mode information corresponds to the pressed enter button G67 or G71, and indicates the selection statement mode or the all item mode. The product code is a product code contained in the transaction statement record identified on the basis of the statement ID. The request change information indicates transaction information after change has been made through user operation performed on the designation changing screen. Hereinafter, the transaction statement record corresponding to the data selected on the registration screen G50 is also referred to as a transaction statement record designated by a user. Furthermore, the statement ID and the product code acquired in step S84 are also referred to as a statement ID designated by a user and a product code designated by a user, respectively.

The POS register device 1 judges whether the mode information acquired indicates the all item mode (S85). If the mode information indicates the all item mode (S85; YES), the POS register device 1 judges whether the transaction statement record designated by the user indicates the limited sales product (S86). More specifically, this judgment is made by judging whether there is any record having special sales information indicating the limited-sale-price applied product, of transaction statement records stored in the transaction-information storage unit 102 and each containing the product code designated by the user. If it is judged that the transaction statement record designated by the user indicates that the product is the limited sales product (S86; YES), the POS register device 1 further judges whether the request change information acquired in step S84 indicates that the quantity is changed into the quantity exceeding the quantity limit (S87).

If it is judged that the request change information indicates that the quantity is changed into the quantity exceeding the quantity limit (S87; YES), the POS register device 1 displays, on the display unit 12a or 22a, an alarm indicating that the change is inappropriate (S88). With these operations, it is possible to maintain the display state of the designation changing screen G70 in the all item mode.

If it is judged that the transaction statement record designated by the user does not indicate the limited sales product (S86; NO), or if the request change information indicates that the quantity is changed into the quantity less than or equal to the quantity limit (S87; NO), the POS register device 1 excludes any transaction statement record having discount information different from the discount information that the transaction statement record designated by the user has, from all transaction statement records each containing the product code designated by the user, and sets the remaining transaction statement record as an application target (S89).

The POS register device 1 applies the predetermined record process using the request change information acquired in step S84 to the transaction statement record serving as the application target (S90), and reflects the transaction statement record having the predetermined record process applied thereto, in the transaction-information storage unit 102.

If it is judged in step S85 that the mode information does not indicate the all item mode, in other words, the mode information indicates the selection statement mode (S85; NO), the POS register device 1 operates in the following manner. First, the POS register device 1 judges whether the special sales information in the transaction statement record designated by the user indicates the limited-sale-price applied product (S91). If it is judged that the special sales information indicates the limited-sale-price applied product (S91; YES), the POS register device 1 reflects the request change information acquired in step S84, and calculates the total quantity sold in the transaction statement records containing the product code designated by the user (S92).

If the total number exceeds the quantity limit (S93; YES), the POS register device 1 displays, on the display unit 12a or 22a, an alarm indicating that this change is inappropriate (S94). With these operations, it is possible to maintain the display state of the designation changing screen G60 in the selection statement mode.

On the other hand, if it is judged that the special sales information indicates that the product is not the limited sales product to which the limited sales price is applied (S91; NO), or if the total number is less than or equal to the quantity limit (S93; NO), the POS register device 1 sets the transaction statement record designated by the user as the application target of the predetermined record process. With these operations, it is possible to apply the predetermined record process using change request information to the transaction statement record designated by the user (S90).

### [Example of Change for Specific Transaction Statement Record]

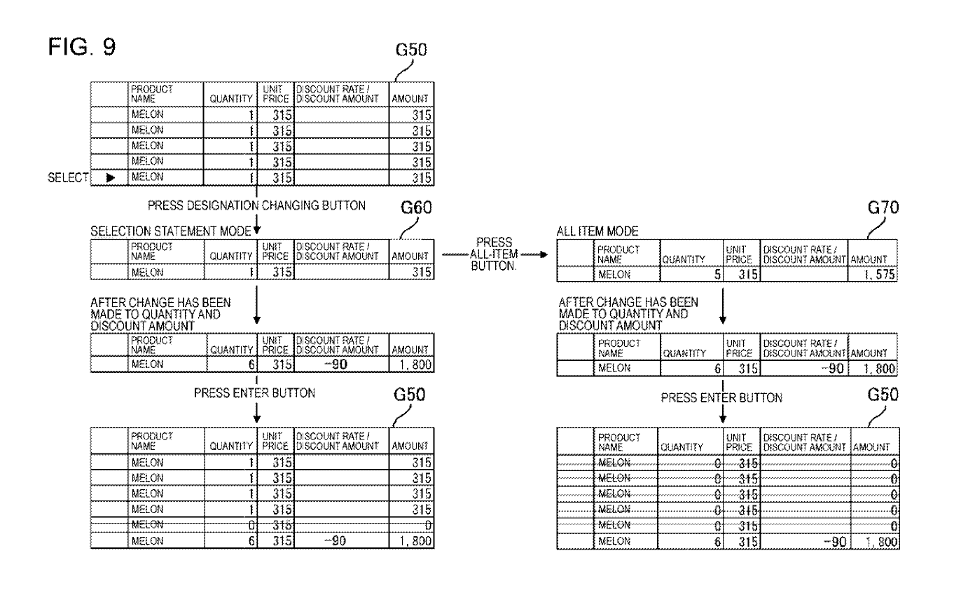

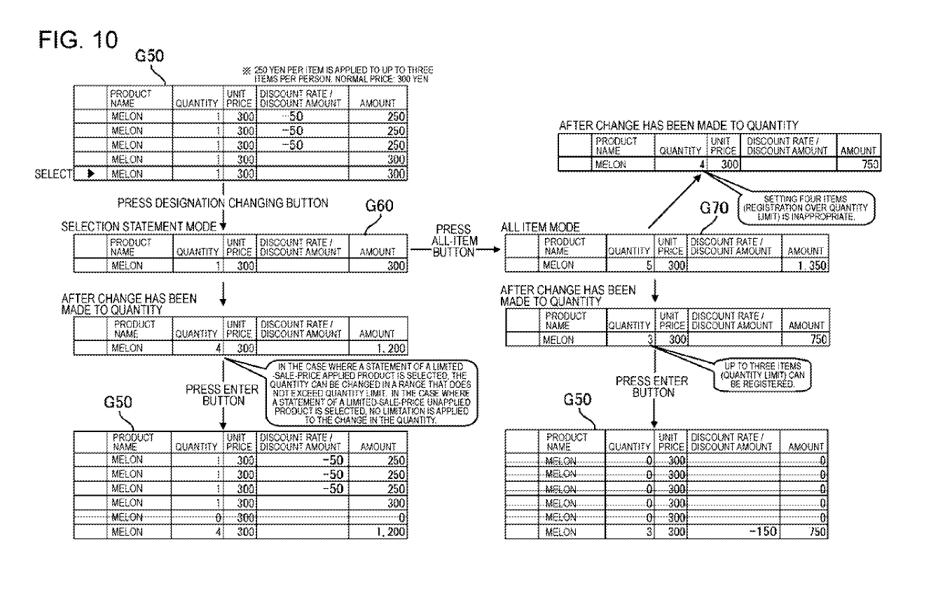

Below, the method of changing a transaction statement will be described in detail with reference to a specific example illustrated in FIG. 9 and FIG. 10. FIG. 9 exemplarily illustrates an example of change for a normal product, and FIG. 10 exemplarily illustrates an example of change for the limited sales product.

In FIG. 9, five melons are registered one by one as items to be checked out. In other words, five transaction statement records concerning a melon are stored in the transaction-information storage unit 102. Accordingly, five items of data (lines) corresponding to five transaction statement records are presented on the registration screen G50 as illustrated in FIG. 9. Here, if the designation changing button G51 is pressed in a state where the lowest line of the five items of data presented on the registration screen G50 is selected, for example, with the keyboard 11, the designation changing screen G60 in the selection statement mode is displayed.

In the case of the example illustrated in FIG. 9, on the designation changing screen G60, the quantity sold is changed from “1” to “6,” the discount information is set so as to be changed from “no discount” to “−90,” and the enter button G67 is pressed. With these operations, the POS register device 1 acquires request change information indicating details of change as described above. Here, a transaction statement record corresponding to the data selected by a user on the registration screen G50 does not indicate the limited sales product, and hence, the POS register device 1 performs the predetermined record process to the transaction statement record corresponding to the selected data.

With this predetermined record process, the delete flag of the transaction statement record corresponding to the data selected by the user is set to be in the deleted state, and a new transaction statement record having this request change information reflected therein is added. As a result, a strike-through line is displayed over the data selected by the user on the registration screen G50 as illustrated in FIG. 9, and the new transaction statement record having the changed setting reflected therein (melon, the quantity sold: 6, and the discount information: −90 yen) is additionally displayed.

On the other hand, if the all-item button G66 is pressed on the designation changing screen G60 in the selection statement mode, the designation changing screen G70 in the all item mode is displayed. On the designation changing screen G70, transaction statement records each concerning a melon and corresponding to the data selected by the user on the registration screen G50 are integrated as illustrated in FIG. 9, thereby being displayed as one item of data (for example, melon, the quantity sold: 5). In the case of the example illustrated in FIG. 9, on the designation changing screen G70, the quantity sold is changed from “5” to “6,” and the discount information is set to be changed from “no discount” to “−90.” With these operations, the POS register device 1 performs the predetermined record process to all the transaction statement records each concerning a melon.

With the predetermined record process, the delete flags of all the transaction statement records each concerning a melon are set to be in the deleted state, and a new transaction statement record having this request change information reflected therein is added. As a result, a strike-through line is displayed over the data corresponding to all the transaction statement records each concerning a melon on the registration screen G50 as illustrated in FIG. 9, and the new transaction statement record having the changed setting reflected therein (melon, the quantity sold: 6, and the discount information: −90 yen) is additionally displayed.

In FIG. 10, an example is given in which the melon in the example illustrated in FIG. 9 is the limited sales product, the quantity limit is three, and the limited sales price is 250 yen. FIG. 10 illustrates that the transaction-information storage unit 102 stores five transaction statement records each concerning a melon, and of the five transaction statement records, the special sales information in three transaction statement records indicates that they are limited-sale-price applied products. Here, if the designation changing button G51 is pressed in a state where the lowest line of the five items of data presented on the registration screen G50 is selected, for example, with the keyboard 11, the designation changing screen G60 in the selection statement mode is displayed. In the example illustrated in FIG. 10, the data selected by the user indicates the limited-sale-price unapplied product.

In the case of the example illustrated in FIG. 10, the quantity sold is set to be changed from “1” to “4” on the designation changing screen G60. Note that, as for the limited sales product, the display is controlled such that the discount information cannot be changed. If the enter button G67 on the designation changing screen G60 is pressed, the POS register device 1 performs the predetermined record process to the transaction statement record corresponding to the selected data as in the example illustrated in FIG. 9. As a result, a strike-through line is displayed over the data selected by the user on the registration screen G50 as illustrated in FIG. 10, and the new transaction statement record (melon, the quantity sold: 4, and the discount information: no discount) is additionally displayed.

Here, in the example illustrated in FIG. 10, if data (any one line of the upper three lines in FIG. 10) corresponding to the limited-sale-price applied product is selected on the registration screen G50, transaction statement records concerning melons of which quantity exceeds three, which is the quantity limit, have been already registered in the transaction-information storage unit 102, and hence, the quantity sold cannot be changed for the transaction statement record corresponding to this data. However, the transaction statement record itself can be deleted.

On the other hand, on the designation changing screen G70 in the all item mode, transaction statement records each concerning a melon are integrated, and are displayed as one data (for example, melon, and the quantity sold: 5) as in FIG. 9. Here, the quantity sold is changed from “5” to “3” on the designation changing screen G70. In such a case, the total quantity sold is less than or equal to the quantity limit, and hence, the POS register device 1 performs the predetermined record process using this request change information to all the transaction statement records each concerning a melon. As a result, a strike-through line is displayed over the data corresponding to all the transaction statement records concerning a melon on the registration screen G50 as illustrated in FIG. 10, and the new transaction statement record (melon, the quantity sold: 3, and the discount information: −150 yen) is additionally displayed. Note that, if the quantity sold is set to be changed from “5” to not less than “4” on the designation changing screen G70, the POS register device 1 displays an alarm because the total quantity sold exceeds the quantity limit.

### Operation and Effect of First Exemplary Embodiment

As described above, in the first exemplary embodiment, products are sequentially registered as items to be checked out for each request for registration. Hence, in the case where a register operator separately registers plural items belonging to the same one product, plural transaction statement records concerning the same one product are stored in the transaction-information storage unit 102. Then, data corresponding to the respective transaction statement records are sequentially displayed on the registration screen according to registration of products as items to be checked out. In such a situation, when correction is desired to any transaction statement record that has been already stored in the transaction-information storage unit 102, one item of data on the registration screen is designated by a user, and a designation changing screen for changing the transaction statement record corresponding to this item of data is displayed. If the all item mode is selected on this designation changing screen, and change information is set, a product code and request change information corresponding to the data designated by the user are acquired, and the predetermined record process using this request change information is applied to plural transaction statement records stored in the transaction-information storage unit 102 and each containing this product code.

Thus, according to the first exemplary embodiment, in the case where plural transaction statement records concerning the same product are stored in the transaction-information storage unit 102, it is only necessary for a user (a register operator) to designate one record of the plural transaction statements (records) concerning the same product, and set changed information, whereby it is possible to collectively correct details of all the transaction statements (records) concerning the same product. With this configuration, even if transaction statement records concerning the same product are sparsely scattered, it is possible to eliminate searching operation for each transaction statement record to be operated, or correction operations for each of the transaction statement records. As a result, according to the first exemplary embodiment, it is possible to make a register operator efficiently change plural transaction statements concerning the same product.

Furthermore, in the first exemplary embodiment, a delete flag is provided for each transaction statement record. At the time of changing transaction statements that have been registered, the delete flags of plural transaction statement records stored in the transaction-information storage unit 102 are set to be in the deleted state. Then, a new transaction statement record having the request change information reflected therein is stored in the transaction-information storage unit 102. With this operation, the data corresponding to the plural transaction statement records before change are made are displayed on the registration screen in a form such that these data are in the deleted state, and one transaction statement record after change has been made is additionally displayed.

According to the first exemplary embodiment, with this configuration, it is possible to present registration information after change has been made, while maintaining the registration state before change is made. Thus, the register operator can recognize the operations performed by him/herself by checking data displayed on the registration screen.

In the first exemplary embodiment, in the case where the transaction statement record designated by a user as the target of change is the limited sales product, an alarm is displayed if operation is performed in a manner such that the quantity sold is changed to be the quantity over the quantity limit. According to the first exemplary embodiment, with this operation, it is possible to appropriately and efficiently make a change to a transaction statement concerning the limited sales product.

Furthermore, in the first exemplary embodiment, a transaction statement, which concerns the product the same as the transaction statement designated by a user as the target of change and to which different discount is applied, is excluded from the target of the collective change. According to the first exemplary embodiment, with this configuration, it is possible to appropriately and efficiently make a change to a transaction statement concerning a product to which a particular discount (discount for closeout products) is applied.

### Modification Example

In the exemplary embodiment described above, a delete flag is provided for each transaction statement record stored in the transaction-information storage unit 102. However, the delete flag may be omitted. In such a case, it is only necessary that the change processing unit 105 actually deletes the transaction statement record serving as the target, rather than setting the delete flag to be in the deleted state.

Furthermore, in the exemplary embodiment described above, the change processing unit 105 remains plural transaction statement records before change is made, and adds a new transaction statement record having request change information reflected therein. However, it may be possible to employ a configuration in which no transaction statement record is added. In such a case, it may be possible to reflect the request change information in one transaction statement record from among plural transaction statement records before change is made, which serve as the target.

In addition, in the exemplary embodiment described above, the selling price information, the discount information, and the special sales information are contained in the transaction information in each of the transaction statement records stored in the transaction-information storage unit 102 as illustrated in FIG. 4. However, it may be possible to employ a configuration in which these pieces of information are not contained in the transaction information, and are extracted from a product information table, a discount information table, or other tables with a product code contained in the transaction statement record being a key to use them.

In the exemplary embodiment described above, an example is given in which the POS register device 1 has the checker device 10 and the cashier device 20. However, the POS register device 1 may be configured only with the cashier device 20.

Furthermore, the POS register device 1 according to the exemplary embodiment described above may be realized as a POS system including a server device and a store terminal.

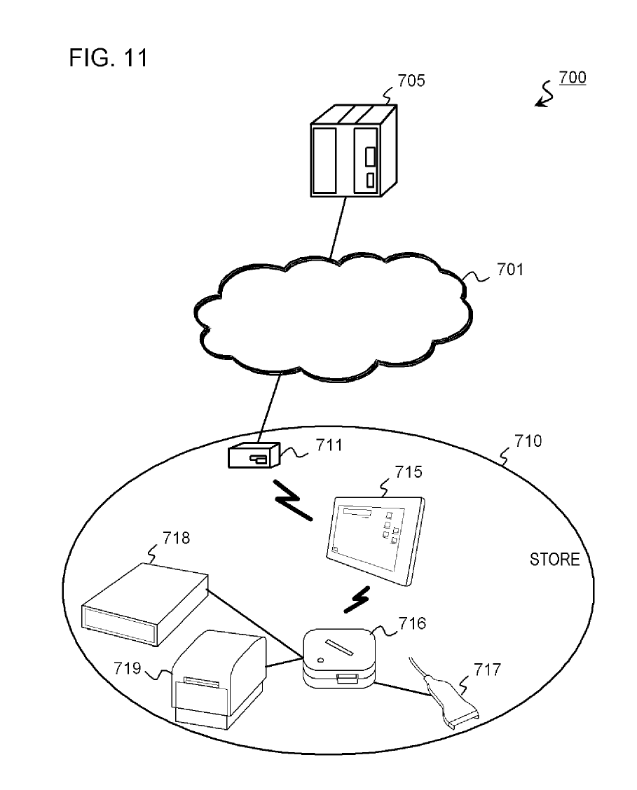

FIG. 11 is a diagram schematically illustrating an example of a configuration of a POS system according to a modification example 700.

The POS system 700 is configured to include a server device 705 and a store-side configuration 710, and the server device 705 and the store-side configuration 710 are connected to each other through a communication network 701 in a manner that they can communicate with each other. The communication network 701 includes, for example, a public network such as the Internet, a wide area network (WAN), a local area network (LAN), and a wireless communication network. The way in which this communication network 701 is realized is not limited.

The store-side configuration 710 includes, for example, a communication relaying device 711, a store terminal 715, a stand 716, a handheld scanner 717, a cash drawer 718, and a receipt printer 719. The stand 716 is a unit for connecting the store terminal 715 with other units (the handheld scanner 717, the cash drawer 718, and the receipt printer 719) in a manner that they can communicate with each other. The store terminal 715 and the stand 716 are connected, for example, through a short-range wireless communication such as Bluetooth (registered trademark) and an infrared communication, or a wireless LAN. The stand 716 is connected to other units through various communication lines or in a wireless manner. The communication relaying device 711 connects the store terminal 715 with the communication network 701, thereby enabling communication between the store terminal 715 and the server device 705. Note that communication modes between these nodes are not limited. It may be possible to employ a configuration in which the communication relaying device 711 is omitted, and the store terminal 715 is connected to the communication network 701, for example, using a 3G communication system, for example, by way of a wireless base station without passing through the communication relaying device 711.

The store terminal 715 is a general purpose computer such as a personal computer (PC), a laptop PC, a tablet-type terminal, and a smartphone, and communicates data with the server device 705, thereby achieving a user interface of the POS register device 1 described above. The server device 705 is a general server computer, and is realized, for example, as a WEB server or an application server.

In the case where the POS register device 1 according to the exemplary embodiment described above is realized as the POS system 700 as described above, each of the processing modules described above may be realized in either the server device 705 or the store terminal 715, as long as it can be realized. For example, in the case where a WEB system is used as an interface between the server device 705 and the store terminal 715, it may be possible to realize all of the processing modules described above in the server device 705, and operate the store terminal 715 as merely a display unit. On the contrary, it may be possible to realize all the processing modules within the store terminal 715. Furthermore, it may be possible to employ a configuration in which part of the processing modules are realized in the server device 705, and the remaining processing modules are realized in the store terminal 715. For example, it may be possible to realize the transaction-information storage unit 102 and the change processing unit 105 in the server device 705, and realize the other processing modules in the store terminal 715.

As described above, it is not excluded that the information processing device according to the present invention is realized with plural devices (plural computers, or a body including plural CPUs). The information processing device according to the present invention may be realized with a combination of the checker device 10 and the cashier device 20 according to the exemplary embodiment described above, or may be realized with a combination of the server device 705 and the store terminal 715 according to this modification example. Needless to say, the information processing device according to the present invention may be realized only with the cashier device 20 according to the exemplary embodiment described above, or may be realized only with the server device 705 or the store terminal 715 according to the modification example.

Furthermore, in the flowchart used in the descriptions above, plural steps (processes) are described in a sequential order. However, the order of the steps performed in the exemplary embodiment is not limited to the order of the steps described. The order of the steps illustrated in the drawing may be exchanged, provided that the exchange does not impair the details of the processes.

The present application claims priority based on Japanese Patent Application No. 2012-173409 filed on Aug. 3, 2012, the disclosures of which are incorporated herein by reference in their entirety.

1. An information processing device, comprising;
a registration processing unit that, in response to a request for registration of a product as an item to be checked out, acquires a product code that enables identification of the product, and transaction information, each of which concerns the product serving as a target of request, and sequentially stores, in a transaction-information storage unit, the product code and the transaction information, which are acquired on a request basis, as one transaction statement record in the requested order;
a display processing unit that causes a display unit to display a registration screen that presents a plurality of items of data corresponding to a plurality of transaction statement records stored in the transaction-information storage unit;
an information acquiring unit that acquires a product code and request change information corresponding to data designated through user operation performed on the registration screen; and
a change processing unit that applies a predetermined record process using the request change information to a plurality of transaction statement records stored in the transaction-information storage unit and each containing the product code acquired by the information acquiring unit.

2. The information processing device according to claim 1, wherein
each of the transaction statement records stored in the transaction-information storage unit further contains a delete flag that indicates whether the record is in a deleted state,
the change processing unit performs, as the predetermined record process wing the request change information, setting the delete flag of each of the plurality of transaction statement records each containing the product code acquired by the information acquiring unit to be the deleted state and adding a new transaction statement record having the request change information reflected therein to the transaction-information storage unit, and
the display processing unit displays the registration screen that presents a plurality of items of data corresponding to a plurality of transaction statement records each having the delete flag indicating the deleted state, in a form that indicates the deleted state.

3. The information processing device according to claim 1, wherein
the transaction information in each of the transaction statement records stored in the transaction-information storage unit contains special sales information that enables determination as to whether a product is a limited sales product to which a limited sales price is applied, and
the change processing unit includes:
a judging unit that judges whether there is any transaction information having special sales information indicating that the product is the limited sales product to which the limited sales price is applied, in transaction information concerning the plurality of transaction statement records each containing the product code acquired by the information acquiring unit, and the quantity sold after change has been made, indicated in the request change information acquired by the information acquiring unit, exceeds quantity limit for the limited sales product or not, and
a determining unit that determines whether to perform the predetermined record process, on the basis of a result of judgment made by the judging unit.

4. The information processing device according to claim 1, wherein
each of the transaction statement records stored in the transaction-information storage unit contains a statement ID that enables identification of the transaction statement record, and each of the transaction information contains discount information,
the information acquiring unit further acquires the statement ID of a transaction statement record corresponding to data designated through user operation performed on the registration screen,
if the discount information contained in the transaction statement record stored in the transaction-information storage unit and identified on the basis of the statement ID acquired by the information acquiring unit indicates that discount is not given, the change processing unit excludes a transaction statement record having discount information indicating that discount is given, of all transaction statement records stored in the transaction-information storage unit and each containing the product code acquired by the information acquiring unit, from a target of application of the predetermined record process.

5. A method of changing a transaction statement, performed by an information processing device, the method including:
in response to a request for registration of a product as an item to be checked out, acquiring a product code that enables identification of the product, and transaction information, each of which concerns the product serving as a target of request;
sequentially storing, in a transaction-information storage unit, the product code and the transaction information, which are acquired on a request basis, as one transaction statement record in the requested order;
causing a display unit to display a registration screen that presents a plurality of items of data corresponding to a plurality of transaction statement records stored in the transaction-information storage unit;
acquiring a product code and request change information corresponding to data designated through user operation performed on the registration screen; and
applying a predetermined record process using the request change information to a plurality of transaction statement records stored in the transaction-information storage unit and each containing the product code corresponding to the data designated through the user operation.

6. The method of changing a transaction statement according to claim 5, wherein
each of the transaction statement records stored in the transaction-information storage unit further contains a delete flag that indicates whether the record is in a deleted state,
the predetermined record process using the request change information includes:
setting the delete flag of each of the plurality of transaction statement records each containing the product code corresponding to the data designated through the user operation, to be the deleted state; and
adding a new transaction statement record having the request change information reflected therein, to the transaction-information storage unit, and
the registration screen presents a plurality of items of data corresponding to a plurality of transaction statement records each having the delete flag indicating the deleted state, in a form that indicates the deleted state.

7. The method of changing a transaction statement according to claim 5, wherein
the transaction information in each of the transaction statement records stored in the transaction-information storage unit contains special sales information that enables determination as to whether a product is a limited sales product to which a limited sales price is applied, and
the method includes:
judging whether there is any transaction information having special sales information indicating that the product is the limited sales product to which the limited sales price is applied, in transaction information concerning the plurality of transaction statement records each containing the product code corresponding to the data designated through the user operation, and the quantity sold after change has been made, indicated in the acquired request change information, exceeds quantity limit for the limited sales product or not; and
determining whether to perform the predetermined record process, on the basis of a result of the judgment.

8. The method of changing a transaction statement according to claim 5, wherein
each of the transaction statement records stored in the transaction-information storage unit contains a statement ID that enables identification of the transaction statement record, and each of the transaction information contains discount information,
the method further includes:
acquiring the statement ID of a transaction statement record corresponding to the data designated through the user operation performed on the registration screen; and
if the discount information contained in the transaction statement record stored in the transaction-information storage unit and identified on the basis of the acquired statement ID indicates that discount is not given, excluding a transaction statement record having discount information indicating that discount is given, of all transaction statement records stored in the transaction-information storage unit and each containing the product code corresponding to the data designated through the user operation, from a target of application of the predetermined record process.

9. A non-transitory computer-readable storage medium storing a program for causing an information processing device to perform a method of changing a transaction statement, the method including:
in response to a request for registration of the product, and transaction out, acquiring a product code that enables identification of the product, and transaction information, each of which concerns the product serving as a target of request;
sequentially storing, in a transaction-information storage unit, the product code and the transaction information, which are acquired on a request basis, as one transaction statement record in the requested order;
causing a display unit to display a registration screen that presents a plurality of items of data corresponding to a plurality of transaction statement records stored in the transaction-information storage unit;
acquiring a product code and request change information corresponding to data designated through user operation performed on the registration screen; and
applying a predetermined record process using the request change information to a plurality of transaction statement records stored in the transaction-information storage unit and each containing the product code corresponding to the data designated through the user operation.

10. The non-transitory computer-readable storage medium according to claim 9, wherein
each of the transaction statement records stored in the transaction-information storage unit further contains a delete flag that indicates whether the record is in a deleted state,
the predetermined record process using the request change information includes:
setting the delete flag of each of the plurality of transaction statement records each containing the product code corresponding to the data designated through the user operation, to be the deleted state; and
adding a new transaction statement record having the request change information reflected therein, to the transaction-information storage unit, and
the registration screen presents a plurality of items of data corresponding to a plurality of transaction statement records each having the delete flag indicating the deleted state, in a form that indicates the deleted state.

11. The non-transitory computer-readable storage medium according to claim 9, wherein
the transaction information in each of the transaction statement records stored in the transaction-information storage unit contains special sales information that enables determination as to whether a product is a limited sales product to which a limited sales price is applied, and
the method includes:
judging whether there is any transaction information having special sales information indicating that the product is the limited sales product to which the limited sales price is applied, in transaction information concerning the plurality of transaction statement records each containing the product code corresponding to the data designated through the user operation, and the quantity sold after change has been made, indicated in the acquired request change information, exceeds quantity limit for the limited sales product or not; and
determining whether to perform the predetermined record process, on the basis of a result of the judgment.

12. The non-transitory computer-readable storage medium according to claim 9, wherein
each of the transaction statement records stored in the transaction-information storage unit contains a statement ID that enables identification of the transaction statement record, and each of the transaction information contains discount information,
the method further includes:
acquiring the statement ID of a transaction statement record corresponding to the data designated through the user operation performed on the registration screen; and
if the discount information contained in the transaction statement record stored in the transaction-information storage unit and identified on the basis of the acquired statement ID indicates that discount is not given, excluding a transaction statement record having discount information indicating that discount is given, of ail transaction statement records stored in the transaction-information storage unit and each containing the product code corresponding to the data designated through the user operation, from a target of application of the predetermined record process.
